(19) United States
(12) Patent Application Publication
(10) Pub. No.: US 2015/0101059 A1
(43) Pub. Date: Apr. 9, 2015

(54) Application License Verification

(71) Applicant: GOOGLE INC., Mountain View, CA (US)

(72) Inventor: Daniel Abram Galpin, Redwood City, CA (US)

(73) Assignee: GOOGLE INC., Mountain View, CA (US)

(21) Appl. No.: 14/049,806

(22) Filed: Oct. 9, 2013

(51) Int. Cl. G06F 21/10

(52) U.S. Cl. CPC G06F 21/10
USPC 726/26

(57) ABSTRACT

An application may provide an application identifier to a client as part of a validation request. The client may request a validation token from a server using the application identifier and a user token provided by the client. The server may send a validation token to the client which, in turn, may send the validation token to the application. The application may establish a secure connection to the server and present the validation token to the server as part of a validation request. The server may validate the application in response to the validation request. The server's response may indicate that the application or content contained in the application is licensed.

### BACKGROUND

Many electronic devices, such as a personal computer, tablet, or smartphone, have the ability to connect to an application store where a user may make a purchase of digital content such as a song, a movie, or an application. Upon making a purchase from the application store, a user may receive a license and the license may be validated periodically or every time the user attempts to access the digital content. Validation of a license typically requires two pieces of information: (1) the account associated with the user and (2) the identification of the application.

### BRIEF SUMMARY

According to an implementation of the disclosed subject matter, an application identifier and a key may be sent to a client. The client may utilize the application identifier, the key, and a user token to obtain a validation token from a server. A validation token may be received from the client based upon the application identifier, the key, and the user token. A secure connection to the server may be established using the validation token and the key. A validation response from the server may be received.

In an implementation, a first request for a validation token may be received from a client. The request may include a user token and an application identifier and a key that were received by the client from an application executing on the same device as the client. The first request may be determined to be valid. A validation token may be provided. A second request to validate the application may be receive via a secure connection with the application. The secure connection may be established using the validation token and the key. The second request may be determined to be valid. A response may be provided to the application indicating that the second request is valid.

A key may be received from a third party server in an implementation. An application identifier and the key may be sent and to a client. The client may utilize the application identifier, the key, and a user token to obtain a validation token from a server. A validation token may be received from the client based upon the application identifier and the user token. The validation token may be provided to the third party server . . . . The third party server may establish a secure connection to the server using the validation token and the key to obtain a validation response. A validation response from the third party server may be received

According to an implementation, a first request for a validation token may be received from a client. The request may include a user token and an application identifier and a key received by the client from an application executing on the same device as the client. The first request may be determined to be valid. A validation token may be provided to the client. A second request to validate the application may be received from the third party server via a secure connection with the application. The secure connection may be established using the validation token and the key. The second request may be determined to be valid and a response may be provided to the third party server indicating that the application is valid.

A system is disclosed that includes a mobile device and a server. The mobile device may be configured to execute a first application and a second application. The server may be configured to provide a validation token to the first application. It may receive a request for validation from the second application over a secure communication channel established based upon the validation token and the key. The server may be configured to determine a validation token request is valid based on a user token, an application identifier, and a key received from the first application. The server may provide a validation response indicating that the second application is valid. The first application may be configured to receive the application identifier and the key from the second application. It may request the validation token from the server. The request may include the user token, the application identifier, and the key. The first application may receive the validation token from the server. The second application may be configured to provide the application identifier, and the key to the first application. It may establish a secure connection to the server using the validation token and the key and it may receive a validation response from the server.

In an implementation a system is provided that includes a mobile device, a server, and a third party server. The mobile device may be configured to execute a first application and a second application. The server may be configured to determine a validation token request is valid based on a user token, an application identifier, and a key received from the first application. It may provide the validation token to the first application and receive a request for validation from a third party server over a secure communication channel that is established based upon the validation token and the key. The server may be configured to provide a validation response indicating that the second application is valid. The third party server may be configured to provide a key to the second application. It may establish a secure connection to the server using the validation token and the key. The third party server may receive a validation response from the server and validate the first application based on the validation response received form the server. The first application may be configured to receive the application identifier and the key from the second application. The first application may request the validation token from the server. The request may include the user token, the application identifier, and the key. It may receive the validation token form the server and provide the validation token to the second application. The second application may be configured to receive the key from the third party server and provide the application identifier and the key to the first application. The second application may be configured to receive the validation token from the first application and send the validation token to the third party server.

An advantage of an implementation disclosed herein is that none of the verification code remains in the client or server. SSL may be used to establish trust with the server. This may allow it to be incorporated easily into a wide variety of server infrastructures, regardless of the programming language or capabilities of the server. Another advantage is that the client may be radically simplified in the basic implementation. Some configurations may take advantage of any digital rights management (“DRM”) technology that the third-party server wishes to use. Additional features, advantages, and implementations of the disclosed subject matter may be set forth or apparent from consideration of the following detailed description, drawings, and claims. Moreover, it is to be understood that both the foregoing summary and the following detailed description provide examples of implementations and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows a computer according to an implementation of the disclosed subject matter.

FIG. 2 shows a network configuration according to an implementation of the disclosed subject matter.

FIG. 3 is an example method for license validation from an application perspective according to an implementation disclosed herein.

FIG. 4 is an example method for license validation from a server perspective according to an implementation disclosed herein.

FIG. 5 is an example method for license validation using a third party server from an application perspective as disclosed.

FIG. 6 is an example method for license validation using a third party server from a server perspective as disclosed.

FIG. 7 is an example system for license validation according to an implementation disclosed herein.

FIG. 8 is an example system for license validation using a third party server according to an implementation disclosed herein.

FIG. 9 is an example overview of communications between a server and an application and client executed on a mobile device.

### DETAILED DESCRIPTION

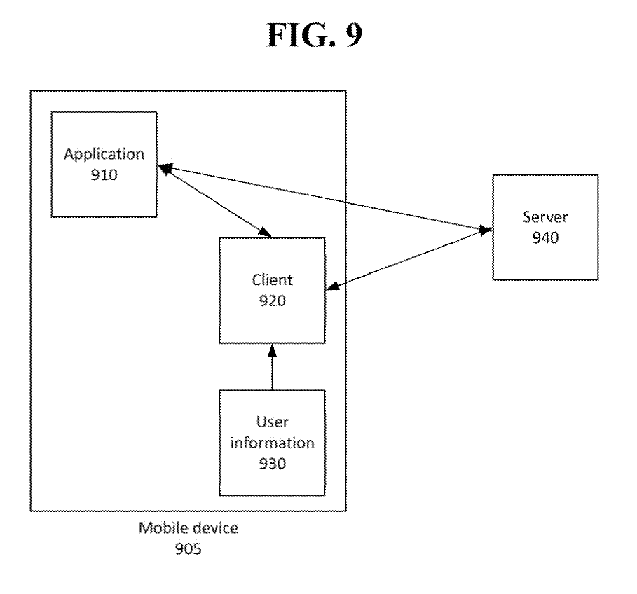

According to implementations disclosed herein, an application (or other digital content item) may determine a license status and allow connected servers to verify the license status of the application without the application having access a user's personal information (e.g., the user's real name, credit card information, address, etc.). For example, in FIG. 9, the application 910 and the client 920 may be executed on a mobile device 905. The client 920 and receive a key, such as a nonce, and an application identifier from the application 910 as a component of a request for license validation from the application 910. The client 920 may access a user's information 930 (the application does not have access to at least a portion of the user's information 930). The client 920 may request a validation token from the server 940 using the application identifier, the key, and at least a portion of the user's information. The server 940 may verify or validate the license by comparing the application identifier and the portion of user information to the like that is stored on a database to which the server is communicatively coupled. If the server 940 validates the license, a validation token may be passed to the client 920, which then passes the token to the application 910. The application 910 may establish a secure connection with the server using the validation token and the key. The server 940 may then validate the license to the application 910, thereby allowing a user to access the application or content therein. Of note, none of the verification code remains in the client or server. SSL may be used to establish trust with the server. Thus, the process disclosed herein does not require the application to know a user's credentials.

The use of a key is optional. For additional security, the request for validation may contain a nonce (e.g., the key) which may be submitted with any verification based upon that token. The nonce may limit use of that token to a single verification. The token may be linked to the user. The application can verify the license to the application or in-application content by making a validated SSL request to the server, either from within the application or by passing the data to a third party server that will contact the server. Using a server of its own allows for the verification to be completely unique on a per-application basis and allows for third-party solutions within the ecosystem.

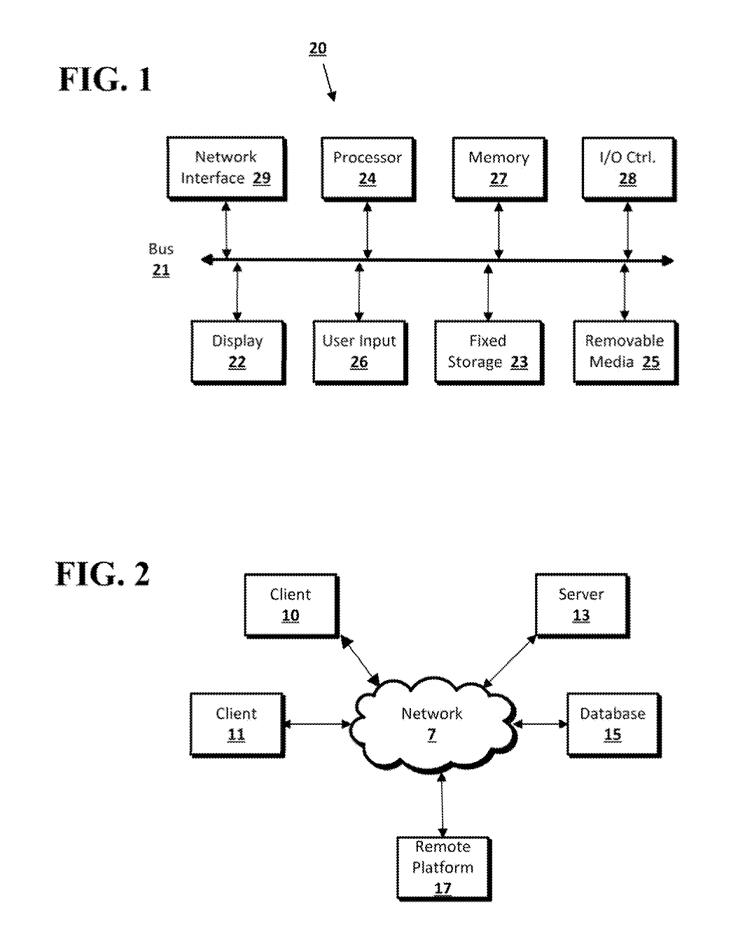

Implementations of the presently disclosed subject matter may be implemented in and used with a variety of component and network architectures. FIG. 1 is an example computer 20 suitable for implementations of the presently disclosed subject matter. The computer 20 includes a bus 21 which interconnects major components of the computer 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 2.

Many other devices or components (not shown) may be connected in a similar manner (e.g., document scanners, digital cameras and so on). Conversely, all of the components shown in FIG. 1 need not be present to practice the present disclosure. The components can be interconnected in different ways from that shown. The operation of a computer such as that shown in FIG. 1 is readily known in the art and is not discussed in detail in this application. Code to implement the present disclosure can be stored in computer-readable storage media such as one or more of the memory 27, fixed storage 23, removable media 25, or on a remote storage location.

FIG. 2 shows an example network arrangement according to an implementation of the disclosed subject matter. One or more clients 10, 11, such as local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

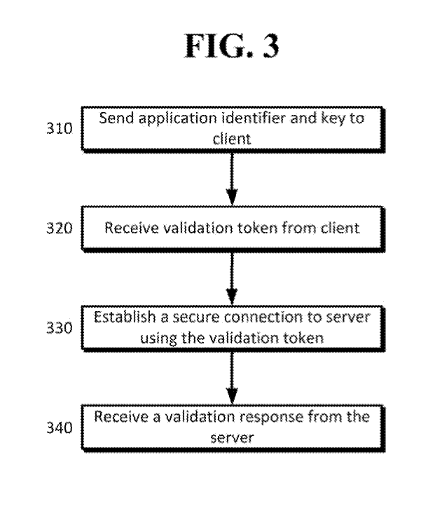

In an implementation, an example of which is provided in FIG. 3, an application identifier and a key may be sent to a client at 310. The client may utilize the application identifier, the key, and a user token to obtain a validation token from a server. An application identifier may refer to a package name assigned to an application associated with the application identifier. For example, an application store may have a package name for Application X as APPX or other alphanumeric sequence or code. APPX may represent an application identifier. A key may refer to a nonce. A nonce may be a cryptographic number that is used only once in a communication. For example, a nonce may be the current time. The application and the client may be executed on the same device. For example, a smartphone may operate an application and simultaneously have a client operating as a background process. In some configurations, a request may be made by the application to the client that instructs the client to obtain a validation token on behalf of the application. The user token may be provided to the server by the client. A user token may include a user's credentials or information about the user. For example, a user token may include credit card information, a user's real name, a user's location (e.g., residence or address), a user's bank account number, an image of the user, a user's password, and/or a user's handle.

A validation token may be received from the client based on the application identifier, the key and the user token at 320. The client may provide the server with the application identifier and the key, which the client obtained from the application, along with the user token as part of a request to obtain a validation token. The server may compare the application identifier and data contained in the user token to that in a database connected to the server. For example, if a user has made a purchase of the application, the fact that the user made such a purchase and is licensed to user the application may be stored in a database connected to the server. Similarly, the application may be a content player and the application may be requesting verification that a user is licensed to play or receive a bit stream of digital content (e.g., a song, album, movie, etc.). The user's digital content purchases may be linked with the user's credentials. For example, a user's purchase history may be stored on a database and associated with the user's name, address, and/or credit card information. The server may respond to the client's request for a validation token with an indication that the application or the request for a validation token is not valid or with the validation token where the request or application are valid. The validation token may be provided to the client, which may pass the validation token to the application. In some configurations, the validation token may be stored in computer readable memory. The client may notify the application of receipt of the token. The application may then search the computer readable memory for the token. The key may be stored temporarily by the device on which the application and/or client are executed and/or the server.

A secure connection to the server may be established using the validation token and the key at 330. The secure connection may be a Secure Sockets Layer protocol. The secure connection may be established by the application and it may present the validation token and the key to the server. The application may not be aware of the user credentials or have any reason to need the user's credentials or other data stored in the user token. A validation response from the server may be received at 340 if the server determines that the validation token and the key match the key that was presented by the client and the token is valid. A validation response may indicate, for example, that an application or content is licensed.

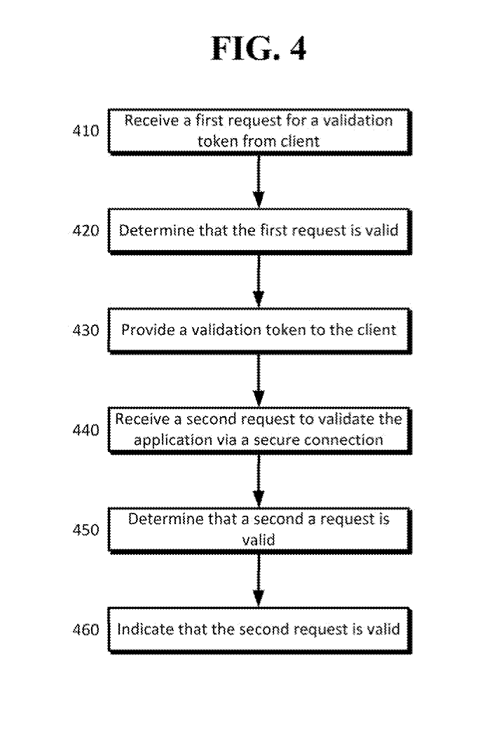

In an implementation, a first request for a validation token may be received from a client, as shown at 410 in the example provided in FIG. 4. The request may include a user token, an application identifier, and a key. The application identifier and the key may be received by the client from an application executing on the same device as the client. As stated earlier, the client may send each of the application identifier, the key and the user token as a component of a request for a validation token. The application may make a request for a validation token to the client or otherwise instruct the client that it requires a validation token. The request may be the transmission of the application identifier and the key to the client. The client may receive the request for a validation token and make the same request to the server on behalf of the application. The client and application may be executed on a device that is physically separate from the server.

At 420, a determination may be made that the first request is valid. As disclosed earlier, the client's request (e.g., the application identifier, the user token, and the key) may be compared to data stored in a database. A validation token may be provided to the client at 430 in the event that the first request is valid (e.g., the application or content therein is licensed by the user). The client may send the validation token to the application. A second request to validate the application may be received via a secure connection with the application at 440. The secure connection may be established between the application and the server using the validation token and the key as described earlier. The second request may include the validation token and the key. The second request may refer to an attempt by the application to determine the validity of a license of the application itself or of digital content accessed by the application (e.g., purchased movies, albums, and/or songs). The second request may be determined to be valid at 450. For example, the server may compare the data included with the second request (e.g., the validation token and/or the key) to data associated with the user from whose device the request originates. The validation token may be valid for a limited time and, thereafter, the validation token may be deemed invalid. An attempt to spoof the validation token may not have the proper user credentials and/or may not have the key. In either or both cases, the server may deem the second request invalid and deny access to the licensed content. In some configurations, the denial of access to the content may be performed by the application. If the validation token is valid and the key matches the key received from the first request, then the server may provide a response to the application to indicate that the second request is valid at 460. For example, the server may indicate to the application that a user has a license to the application or to a song that the user has requested to be played by the application.

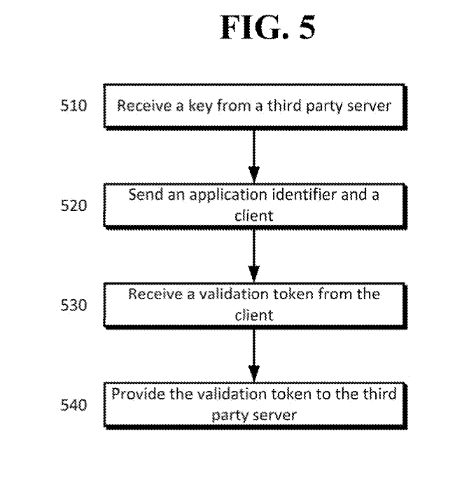

According to an implementation, an example of which is provided in FIG. 5, a key may be received from a third party server at 510. The key may be a nonce as stated earlier. An application identifier and the key may be sent to a client at 520. The application identifier may be provided by the application. The application may request and receive a key from the third party server. The application may provide the key to the client or the third party client may send the key directly to the client. The client may utilize the application identifier, the key and a user token to obtain a validation token from a server. The server and the third party server may be physically separate. The user token may be provided by the client and may contain a user's credentials, for example, as disclosed earlier. A validation token may be received from the client based on the application identifier and the user token at 530. For example, the client may receive a request from an application for a validation token. The client may make a request for a validation token from a server. The server may return a validation token if the clients request is valid. The client may pass the token to an application or to the third party server. If the validation token is sent to the application, then the application may send the validation token to the third party server. The validation token may be provided to the third party server at 540. The third party server may establish a secure connection to the server using the validation token and the key to obtain a validation response from the server. The third party server may receive a validation response from the server indicating that the application is licensed or that digital content that application is attempting to access is licensed.

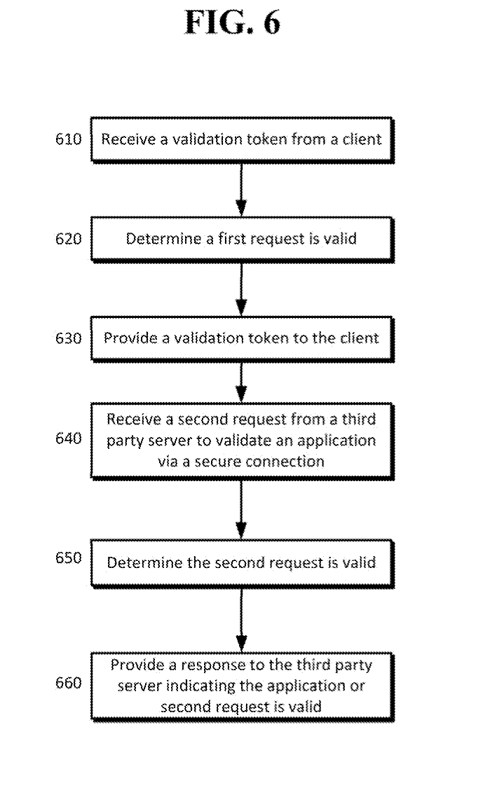

In an implementation, a first request for a validation token may be received from a client as shown in the example provided in FIG. 6 at 610. The request may include a user token, an application identifier, and a key. The application identifier and the key may be received by the client from an application executing on the same device as the client. The application may request and receive the key from a third party server. In some configurations, the third party server may provide the key directly to the client. A first request may be determined to be valid at 620, for example, by the server as described earlier. A validation token may be provided to the client, for example, by the server at 630. The client may send the validation token to the third party server. A second request may be received from the third party server to validate the application via a secure connection with the third party server (e.g., between the server and the third party server) at 640. The secure connection may be established using the validation token and the key. Validating the application may refer to receiving an indication from the server that the application or content the application is attempting to access licensed. The second request may be determined to be valid at 650. A response to the third party server indicating that the application or second request is valid may be provided, for example, by the server at 660.

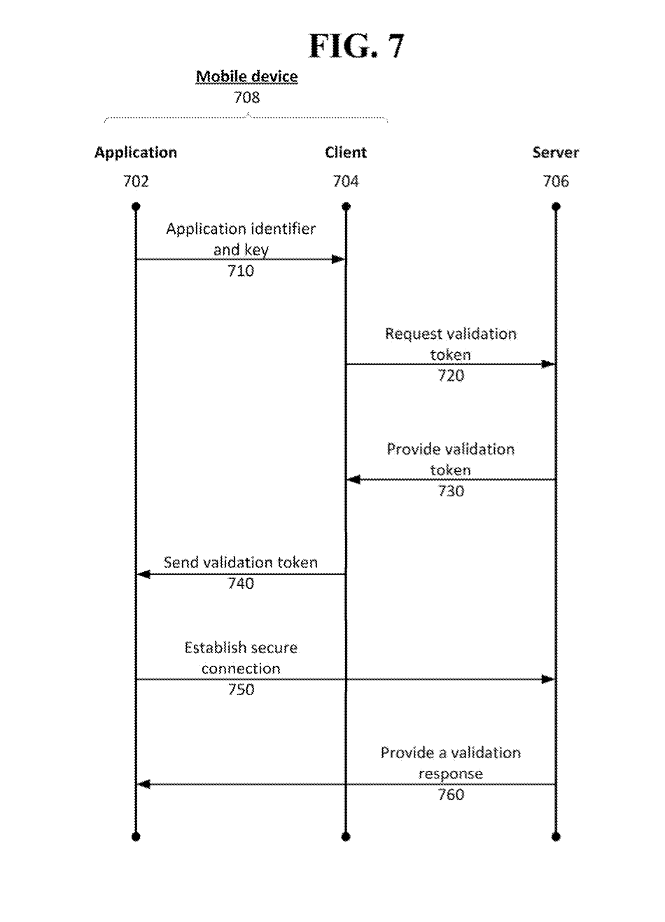

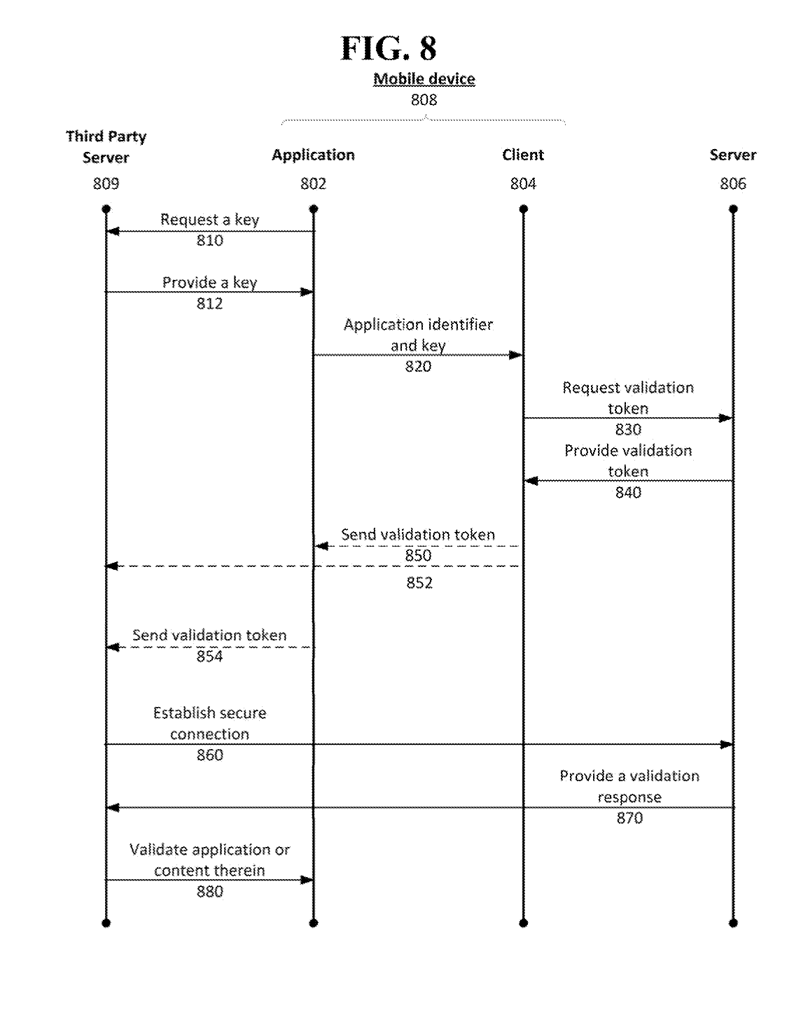

A system is provided in an implementation, as shown in the example provided in FIG. 7. The system may include a mobile device 708 and a server 706. The mobile device 708 may be configured to execute a client 704 and an application 702. The client 704 may be configured to receive an application identifier and a key at 710 from the application 702. The mobile device 708 and/or the server 706 may be configured to store the key in computer readable memory. The application 702 may be configured to provide the application identifier and the key to the client 704. For example, the application 702 may request a validation token, for example, from the client 704 and the request may include the application identifier and the key. The client 704 may be configured to request and/or receive the validation token at 720 from the server 706. The request may include a user token, the application identifier, and the key as described earlier. The server 706 may be configured to provide a validation token to the client 704, for example, if the request made by the client 704 is valid at 730 as described above. The client 704 may receive the validation token from the server 706 and send the validation token to the application 702 at 740. The application 702 may establish a secure connection to the sever 706 using the validation token and the key at 750. The server 706 may be configured to receive a request for validation from the application 702 over the secure connection. The server 706 may determine whether the request for validation by the application 702 is valid or not as described earlier. The server 706 may provide a validation response indicating that the application 702 is valid (e.g., the application 702 or content the application 702 is accessing is licensed) at 760. The application 702 may be configured to receive the validation response from the server 706.

A system is provided in an implementation that includes a mobile device 808, a third party server 809, and a server 806. The mobile device 808 may be configured to execute the client 804 and an application 802. The application 802 may be configured to request 810 and receive 812 a key from a third party server 809. The third party server 809 may be configured to receive the request and, in response to the request, provide the key to the application 802. The application 802 may provide the key and the application identifier to the client 804 at 820. The client 804 may be configured to receive the application identifier and the key from the application 802. The client 804 may request a validation token from the server 806 at 830. The request may include a user token, the application identifier, and the key. The server 806 may determine the validation request is valid based on the user token, an application identifier, and the key received from the client 804. At 840 it may provide a validation token to the client 804. The client 804 may be configured to receive the validation token and provide it to the application 802 at 850 or the third party server 809 at 852. The application 802 may be configured to receive the validation token from the client 804 and send the validation token to the third party server 809 at 854. The third party server 809 may be configured to receive the validation token from the application 802 or the client 804. The third party server 809 may establish a secure connection to the server 806 using the validation token and the key at 860. The server 806 may be configured to receive a request for validation form the third party server 809 over the secure connection. If the validation token and key provided by the third party server 809 with the request are valid (e.g., the key matches the key provided by the client 804 and the validation token has not expired), then the sever 806 may provide a validation response to the third party server 809 indicating that the application 802 or content the application 802 is attempting to access is licensed (e.g., is valid) at 870. The third party server may be configured to receive the validation response provided by the server 806. The third party server 809 may validate the application 802 or content the application 802 is attempting to access based on the response from the server 806 at 880. Validating the application 802 or content the application 802 is attempting to access may refer to allowing the application 802 to execute code that would otherwise not be executed if the application 802 were deemed invalid. Similarly, it may refer to allowing the application 802 to access content (e.g., play a movie or a song). The application 802 may receive an indication of validation from the third party server 809 and execute code or access content that it would otherwise not have been able to execute or access but for the validation.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A method comprising:
sending, from an application to a client, an application identifier and a key, wherein the client utilizes the application identifier, the key and a user token to obtain a validation token from a server, the validation token indicating that a first validation has been performed by the server comprising a comparison of the application identifier and the key to values stored in a database accessible by the server;
receiving, by the application from the client, the validation token;
establishing, from the application, an encrypted connection to the server using the validation token and the key; and
receiving, by the application, a validation response from the server indicting that a second validation has been performed by the server, the second validation comprising a determination that the encrypted connection was established with the key and a determination that the validation token has not expired.

2. The method of claim 1, wherein the application identifier comprises a package name assigned to an application associated with the application identifier.

3. The method of claim 1, wherein the key comprises a nonce.

4. The method of claim 1, wherein the encrypted connection comprises Secure Sockets Layer protocol.

5. The method of claim 1, wherein the validation response comprises an indication that an application is licensed.

6. The method of claim 1, further comprising storing the key.

7. The method of claim 1, wherein the user token comprises information selected from the group consisting of: a credit card number, a name, a location, a bank account number, an image, a password, and a user handle.

8. A method, comprising:
receiving, by a server, a first request for a validation token from a client, the first request comprising a user token, an application identifier, and a key, wherein the application identifier and the key are received by the client from an application executing on the same device as the client;
determining, by the server, that the first request is valid by comparing the application identifier, the key, and the user token against a server database;
providing, by the server, a validation token to the client upon the determination that the first request is valid;
receiving, by the server, a second request to validate the application via an encrypted connection with the application, the encrypted connection established using the validation token and the key;
determining, by the server, that the second request is valid by determining the encrypted connection was established with the key and by determining that the validation token has not expired; and
providing a response to the application indicating that the second request is valid.

9. The method of claim 8, wherein the client receives the first request from an application executed on the same device as the client

10. The method of claim 8, wherein the application identifier comprises a package name assigned to an application associated with the application identifier.

11. The method of claim 8, wherein the key comprises a nonce.

12. The method of claim 8, wherein the encrypted connection comprises Secure Sockets Layer protocol.

13. The method of claim 8, wherein the client and application are executed on a device that is physically separate from the server.

14. The method of claim 8, wherein the determination that the second request is valid comprises an indication that an application is licensed.

15. The method of claim 8, further comprising storing the key.

16. The method of claim 8, wherein the user token comprises information selected from the group consisting of: a credit card number, a name, a location, a bank account number, an image, a password, and a user handle.

17-30. (canceled)

31. A system, comprising:
a mobile device configured to execute a client and an application; and
wherein the client is configured to:
receive an application identifier and a key from the application;
request, from a server, a validation token, wherein the request comprises a user token, the application identifier, and the key;
receive the validation token from the server indicating that a the server has compared the user token, the key, and the application identifier to values stored in a database accessible by the server; and
wherein the application is configured to:
provide the application identifier and the key to the client;
establish an encrypted connection to the server using the validation token and the key; and
receive a validation response from the server indicating that the encrypted connection was established with the key and that the validation token has not expired.

32. The system of claim 31, further comprising:
the server configured to:
provide the validation token to the client;
receive the request for validation from the application over the secure connection established based upon the validation token and the key;
determine the validation request is valid based on the user token, the application identifier, and the key received from the client; and
provide a validation response indicating that the application is valid.

33. The system of claim 31, wherein the application identifier comprises a package name assigned to an application associated with the application identifier.

34. The system of claim 31, wherein the key comprises a nonce.

35. The system of claim 31, wherein the encrypted connection comprises Secure Sockets Layer protocol.

36. The system of claim 31, wherein the validation response comprises an indication that the application is licensed.

37. The system of claim 31, the mobile device further configured to store the key.

38. The system of claim 31, wherein the user token comprises information selected from the group consisting of: a credit card number, a name, a location, a bank account number, an image, a password, and a user handle.
